(19) United States
(12) Patent Application Publication
(10) Pub. No.: US 2004/0250169 A1
(43) Pub. Date: Dec. 9, 2004

(54) IDS log analysis support apparatus, IDS log analysis support method and IDS log analysis support program

(75) Inventors: Keisuke Takemori, Kamifukuoka-shi (JP); Koji Nakao, Kamifukuoka-shi (JP)

Correspondence Address: Edwards & Angell, LLP, Intellectual Property Practice Group, P.O. Box 55874, Boston, MA, 02205, US

(73) Assignee: KDDI Corporation

(21) Appl. No.: 10/824,823

(22) Filed: Apr. 14, 2004

(30) Foreign Application Priority Data
Apr. 17, 2003 (JP) 2003-112414

(51) Int. Cl. H02H 3/05

(52) U.S. Cl. 714/38

(57) ABSTRACT

There is provided an IDS log analysis support apparatus, an IDS log analysis support method, and an IDS log analysis support program that enable logs that are different from normal logs to be extracted from logs output in great quantity from a variety of IDS, and enable the degree of abnormality thereof to be objectively evaluated. The apparatus has a log collection section that collects logs of IDS that are connected to a telecommunication network, a database that stores and manages logs collected by the log collection section, and a log analysis section that obtains statistics of logs managed by the database and performs analysis processing thereon.

### BACKGROUND OF THE INVENTION

1. Field of the Invention

The present invention relates to an intrusion detection system (IDS) log analysis support apparatus, an IDS log analysis support method, and an IDS log analysis support program that support analysis of a log output from an intrusion detection system.

Priority is claimed on Japanese Patent Application No. 2003-112414, filed Apr. 17, 2003, the content of which is incorporated herein by reference.

2. Description of Related Art

In recent years, sites that have introduced network type intrusion detection systems (referred to hereinafter simply as “IDS”) in order to monitor attacks on network systems have increased. Typically, IDS are formed by a detection engine that detects attacks by monitoring traffic, and a control console that performs centralized management and analysis of the log obtained by monitoring traffic. A large number of detection engines simply compare packets flowing on the network with attack pattern files known as signatures, and output a log if any of these are matching. The control console has a function of displaying output logs in chronological order and a function of performing simple statistical processing.

Moreover, conventionally, a log information analysis apparatus has been proposed whose aims are to reduce the time required for the task of analyzing log information showing the operating state of a computer, integrating log information having various data formats and having uneven distribution of file systems, and extracting log information showing unknown abnormalities. This log information analysis apparatus displays an enormous quantity of log information that is based on characters as a bar graph so that a system administrator can rapidly ascertain information needing to be observed (see, for example, Japanese Unexamined Patent Application, First Publication No. 2001-356939).

However, in the log information analysis apparatus described in Japanese Unexamined Patent Application, First Publication No. 2001-356939, log data output from a host is monitored, and the method of analysis involves visually presenting abnormalities relating to word occurrence frequency or text length. This apparatus therefore has the following drawbacks.

Namely, the log information analysis apparatus described in Japanese Unexamined Patent Application, First Publication No. 2001-356939 is not able to be applied to log analysis of an IDS that monitors attacks on a network. Moreover, in the log information analysis apparatus described in Japanese Unexamined Patent Application, First Publication No. 2001-356939, the mathematical technique of the analysis algorithm is not clear, and the result of analysis cannot be output as objective numerical values. Furthermore, the log information analysis apparatus described in Japanese Unexamined Patent Application, First Publication No. 2001-356939 is not dedicated to an attack log, lawful actions that are different from the usual actions are also detected.

In addition, conventionally, there are many cases in which an IDS that has been introduced is left alone and is not utilized effectively. This problem mainly arises as a result of it not being possible to analyze redundant logs that are output in great quantity such as misdetections, multiple detections, and detections of attacks on systems that have already been provided with security countermeasures. Furthermore, when a simple matching type of IDS is being used, these problems are also caused by the fact that determination as to the intent of an attack and success or failure thereof is difficult.

In known IDS, although there is a function for performing simple statistics, the determination as to how dangerous attacks indicated by the statistical values are depends on the experience and personal judgment of an operator. In addition to this, the formats of logs output by IDS being used are different and the reactions of the IDS to an attack are diverse. Moreover, conventionally, the drawback also exists that it is necessary to ascertain the characteristics of an output log for each IDS used for monitoring. In this manner, conventionally, it is not possible to objectively extract traces that are different from normal from among a huge quantity of logs that are output from a variety of IDS.

Techniques of filtering logs output in a large quantity that may be considered include a policy tuning technique in which signatures that do not need to be monitored are removed from the detection engine, and a filtering technique in which, using inspecting data relating to the vulnerability of a network, a control console removes a log of attacks on a system for which countermeasures have been implemented from the subjects being analyzed.

However, in the aforementioned policy tuning technique drawbacks exist such as the costs incurred by the policy tuning, human error such as when vital signatures are mistakenly removed, and also a large number of logs that may be thought not worth looking at becoming necessary in the analysis of an intruder attempting an attack from a variety of angles. In the aforementioned filtering technique drawbacks include human error such as the mistaken installation of uninspected systems, and the costs of inspection each time a system is introduced.

### SUMMARY OF THE INVENTION

The present invention was conceived in view of the circumstances above described, and it is an object thereof to provide an IDS log analysis support apparatus, an IDS log analysis support method, and an IDS log analysis support program that enable logs that are different from normal logs to be extracted from logs output in great quantity from a variety of IDS, and enable the degree of abnormality thereof to be objectively evaluated.

A first aspect of the present invention is an IDS log analysis support apparatus that comprises: a log collection section that collects a log of an intrusion detection system that is connected to a telecommunication network; a database that stores and manages logs collected by the log collection section; and a log analysis section that obtains statistics of the logs managed by the database and analyses the statistics.

A second aspect of the present invention is an IDS log analysis support method that comprises the steps of: regularly collecting a log of an intrusion detection system that is connected to a telecommunication network; storing logs in a database and managing the logs; and obtaining statistics of the logs managed by the database and performing analysis processing on the statistics.

A third aspect of the present invention is an IDS log analysis support program that analyzes a log of an intrusion detection system connected to a telecommunication network, the IDS log analysis support program executing on a computer: a log collection step in which logs are collected from the intrusion detection system; a database creation step in which the logs collected in the log collection step are stored and the stored logs are managed; and a log analysis step in which statistics are obtained for the logs managed in the database creation step and the statistics are analyzed.

According to the present invention, because statistical analysis is performed on logs output successively in a large quantity from an intrusion detection system, it is possible to objectively evaluate the logs, for example, by taking the difference between characteristics of a short time period of the logs relative to characteristics (for example, an average value or the like) of a long time period of the logs as an abnormality value.

In the first aspect of the present invention, the log analysis section may comprise an internal and external similarity analysis device that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected subject side, and sequentially calculates a degree of similarity that shows an extent to which the inward log and the outward log match based on the result of the comparison, and determines whether or not an abnormality has occurred based on the degree of similarity.

In the second aspect of the present invention, the analysis processing may comprise internal and external similarity analysis processing that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected subject side, and determines whether or not an abnormality has occurred using a degree of similarity that shows an extent to which the inward log and the outward log match based on the results of the comparison.

In the third aspect of the present invention, the log analysis step may comprise an internal and external similarity analysis step that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected object side, and determines whether or not an abnormality has occurred using a degree of similarity that shows an extent to which the inward log and the outward log match based on the result of the comparison.

According to these inventions, successive determinations are made about degrees of similarity between an inward log, which is a log of accesses made, for example, from the Internet or the like to a subject of protection of the intrusion detection system, with an outward log, which is a log of accesses made from this subject of protection to the outside such as the Internet or the like. Normally, attack events such as worms are present in a large number in inward logs, while dangerous events are comparatively rare in outward logs. Therefore, according to the present invention, if, for example, these degrees of similarity suddenly begin to match, it can be determined that there is a possibility that the subject of protection has been infected by a worm or the like.

In the first aspect of the present invention, the log analysis section may comprise an access country analysis device that, taking as a subject to be detected a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

In the second aspect of the present invention, the analysis processing may comprise access country analysis processing that sequentially detects an occurrence frequency of a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

In the third aspect of the present invention, the log analysis step may comprise an access country analysis step that sequentially detects an occurrence frequency of a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

According to these inventions, because the country name of the transmission source is successively analyzed, it is possible to ascertain the spread of a new attack, and it is possible to quickly and objectively detect that an abnormal state has arisen. This is for the reason that because, generally, the country of the transmission source that is accessing the subject of protection of the intrusion detection system is often the same as the country to which the subject of protection belongs, for example, if accesses from a foreign country suddenly increase, then it can be determined that an abnormal state has arisen.

In the first aspect of the present invention, the log analysis section may comprise an access country analysis device that, taking as a subject to be detected a name of a country to which belongs a transmission source of an inward log in the logs, which is a log of accesses made from a non-protected subject side of the intrusion detection system to a protected subject side of the intrusion detection system, determines that an abnormality has occurred when there is an increase in the occurrence frequency of a country name that is not normally detected.

In the second aspect of the present invention, the analysis processing may comprise access country analysis processing that sequentially detects an occurrence frequency of a name of a country to which belongs a transmission source of an inward log in the logs, which is a log of accesses made from a non-protected subject side of the intrusion detection system to a protected subject side of the intrusion detection system, and determines that an abnormality has occurred when there is an increase in the occurrence frequency of a country name that is not normally detected.

In the third aspect of the present invention, the log analysis step may comprise an access country analysis step that sequentially detects an occurrence frequency of a name of a country to which belongs a transmission source of an inward log in the logs, which is a log of accesses made from a non-protected subject side of the intrusion detection system to a protected subject side of the intrusion detection system, and determines that an abnormality has occurred when there is an increase in the occurrence frequency of a country name that is not normally detected.

According to these inventions, because the country name of the transmission source is successively analyzed, it is possible to ascertain the spread of a new attack, and it is possible to quickly and objectively detect that an abnormal state has arisen.

In the first aspect of the present invention, the log analysis section may comprise an access country analysis device that, taking as a subject to be detected a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

In the second aspect of the present invention, the analysis processing may comprise access country analysis processing that sequentially detects an occurrence frequency of a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

In the third aspect of the present invention, the log analysis step may comprise an access country analysis step that sequentially detects an occurrence frequency of a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

According to these inventions, it is possible to detect that a subject of protection has been infected by a virus or has become a host used as a springboard (hereinafter referred to as a “springboard host”). This is because if, for example, accesses from the subject of protection to a foreign country suddenly increase, the subject of protection has often been infected by a virus or has become a springboard host.

In the first aspect of the present invention, the log analysis section may comprise an access country analysis device that, taking as a subject to be detected a name of a country to which belongs a transmission destination of an outward log, which is a log of accesses made from a protected subject side of the intrusion detection system to a non-protected subject side of the intrusion detection system that are in the logs, determines that an abnormality has occurred when there is an increase in the occurrence frequency of a country name that is not normally detected.

In the second aspect of the present invention, the analysis processing may comprise access country analysis processing that sequentially detects an occurrence frequency of a name of a country to which belongs a transmission destination of an outward log in the logs, which is a log of accesses made from a protected subject side of the intrusion detection system to a non-protected subject side of the intrusion detection system, and determines that an abnormality has occurred when there is an increase in the occurrence frequency of a country name that is not normally detected.

In the third aspect of the present invention, the log analysis step may comprise an access country analysis step that sequentially detects an occurrence frequency of a name of a country to which belongs a transmission destination of an outward log in the logs, which is a log of accesses made from a protected subject side of the intrusion detection system to a non-protected subject side of the intrusion detection system, and determines that an abnormality has occurred when there is an increase in the occurrence frequency of a country name that is not normally detected.

According to these inventions, it is possible to detect that a subject of protection has been infected by a virus or has become a springboard host.

In the first aspect of the present invention, the log analysis section may comprise a ratio analysis device that compares a short term number of events, which is the number of a predetermined event contained in a predetermined unit time period in the logs, with an average value of a short term number of events for a plurality of the unit time periods, and determines whether or not an abnormality has occurred based on a ratio of the short term number of events relative to the average value.

In the second aspect of the present invention, the analysis processing may comprise ratio analysis processing that sequentially calculates a ratio between a short term number of events, which is the number of a predetermined event contained in a predetermined time period in the logs, and a long term number of events, which is the number of the predetermined event contained in a time period that is longer than the predetermined time period, and determines whether or not an abnormality has occurred based on the ratio.

In the third aspect of the present invention, the log analysis step may comprise a ratio analysis step that sequentially calculates a ratio between a short term number of events, which is the number of a predetermined event contained in a predetermined time period in the logs, and a long term number of events, which is the number of the predetermined event contained in a time period that is longer than the predetermined time period, and determines whether or not an abnormality has occurred based on the ratio.

According to these inventions, if, for example, the ratio of the short term number of events relative to an average value suddenly increases, it can be determined that an attack has begun on a subject of protection or that a worm has infected a subject of protection. Moreover, if, for example, the ratio of the short term number of events relative to an average value suddenly decreases, it can be determined that a portion of the functions of the subject of protection (i.e., a host or internal network or the like) have stopped.

In the first aspect of the present invention, the log analysis section may comprise a threshold learning device that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

In the second aspect of the present invention, the analysis processing may comprise threshold learning analysis processing that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

In the third aspect of the present invention, the log analysis step may comprise a threshold learning analysis step that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

According to these inventions, because a standard deviation value or the like is calculated for the log of an intrusion detection system, and it is determined whether or not an abnormality has occurred using that standard deviation, it is possible to determine whether or not an abnormality has occurred while considering the degree of dispersion in a desired number of events (i.e., data) in the log.

In the first aspect of the present invention, a plurality of intrusion detection systems may be connected to the telecommunication network, and the plurality of intrusion detection systems each may have a different protected subject, and the log analysis section may comprise an IDS comparison device that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

In the second aspect of the present invention, a plurality of intrusion detection systems may be connected to the telecommunication network, and the plurality of intrusion detection systems each may have a different protected subject, and the analysis processing may comprise IDS comparison processing that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

In the third aspect of the present invention, a plurality of the intrusion detection systems may be connected to the telecommunication network, and the plurality of intrusion detection systems each may have a different protected subject, and the log analysis step may comprise an IDS comparison step that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

According to these inventions, when a plurality of IDS are monitoring different subjects of protection (i.e., intranets and the like), it is possible to determine whether or not an abnormality has occurred in a specific subject of protection (i.e., intranet or the like) from among all the subjects of protection (an entire network or the like) of the plurality of IDS. Namely, while, conventionally, a determination was made as to the log of one IDS unit, according to the present invention, it is possible to compare all the logs of a plurality of IDS with the log of one IDS from among this plurality, and to determine the degree of abnormality of the log of each IDS.

In the first aspect of the present invention, the IDS comparison device may comprise a variable state comparison device that compares a variable state that accompanies an elapsed time of the monitored profile with a variable state that accompanies an elapsed time of the integrated profile, and determines that an abnormality has occurred when the difference between the variable states is equal to or greater than a predetermined value.

In the second aspect of the present invention, the IDS comparison processing may comprise variable state comparison processing that compares a variable state that accompanies an elapsed time of the monitored profile with a variable state that accompanies an elapsed time of the integrated profile, and determines that an abnormality has occurred when the difference between the variable state is equal to or greater than a predetermined value.

In the third aspect of the present invention, the IDS comparison step may comprise a variable state comparison step that compares a variable state that accompanies an elapsed time of the monitored profile with a variable state that accompanies an elapsed time of the integrated profile, and determines that an abnormality has occurred when the difference between the variable states is equal to or greater than a predetermined value.

According to these inventions, for example, when the variable state of an integrated profile is stable, if the variable state of the monitored profile abruptly increases for a predetermined item, it is possible to determine that there is a possibility that a subject of protection of a particular IDS has been infected by a worm.

As has been described above, according to the present invention, it is possible to rapidly extract logs that are different from normal logs from logs output in great quantity from a variety of IDS, and to objectively evaluate the degree of abnormality thereof.

### BRIEF DESCRIPTION THE DRAWINGS

FIG. 1 is a typical view showing an IDS log analysis support system according to an embodiment of the present invention.

FIG. 2 is a view showing an example of display of a log analyzed by the above system.

FIG. 3 is a view showing an event table of a database of the above system.

FIG. 4 is a view showing a signature table of the above database.

FIG. 5 is a view showing an event parameter table of the above database.

FIG. 6 is an explanatory view of a ratio analysis model (a ratio analysis device) of the above system.

FIG. 7 is an explanatory view of a threshold learning model (a threshold learning device) of the above system.

FIG. 8 is an explanatory view showing a variety of attack modes.

### DETAILED DESCRIPTION OF THE INVENTION

An embodiment of the present invention will now be described with reference made to the drawings.

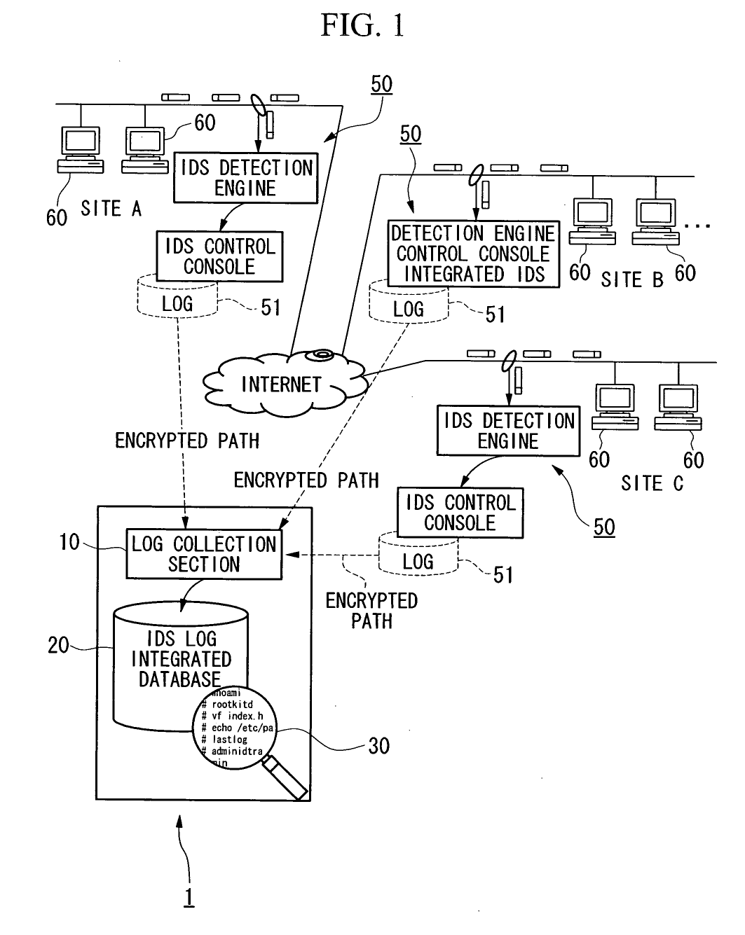

FIG. 1 is a typical view showing an applicable mode and structure of an IDS log analysis support system according to an embodiment of the present invention.

An IDS log analysis support system 1 of the present embodiment collects logs 51 from IDS 50 introduced into each of a plurality of sites A, B, and C that are connected to the Internet, and manages and analyzes these logs. Various types of server 60 such as WWW servers and mail servers and client computers are placed at each of the sites A, B, and C. The sites A, B, and C are each protected by an IDS 50.

The IDS log analysis support system 1 (the IDS log analysis support apparatus) is provided with a log collection section 10, an IDS log integrated database (referred to hereinafter simply as a “database”) 20, and a log analysis section 30. The log collection section 10 collects at regular intervals logs 51 that are output sequentially from the respective IDS 50 of each of the sites A, B, and C. The database 20 stores and manages the logs 51 collected by the log collection section 10. The log analysis section 30 performs statistical analysis processing on the logs 51 managed by the database 20.

The log collection section 10 collects, at regular intervals via encrypted paths, logs 51 on the control console of the IDS 50 and logs 51 on the IDS 50 obtained by integrating the detection engine and control console, and stores them in the database 20 which has an integrated format. The log analysis section 30 performs various types of analysis processing on the logs managed by the database 20.

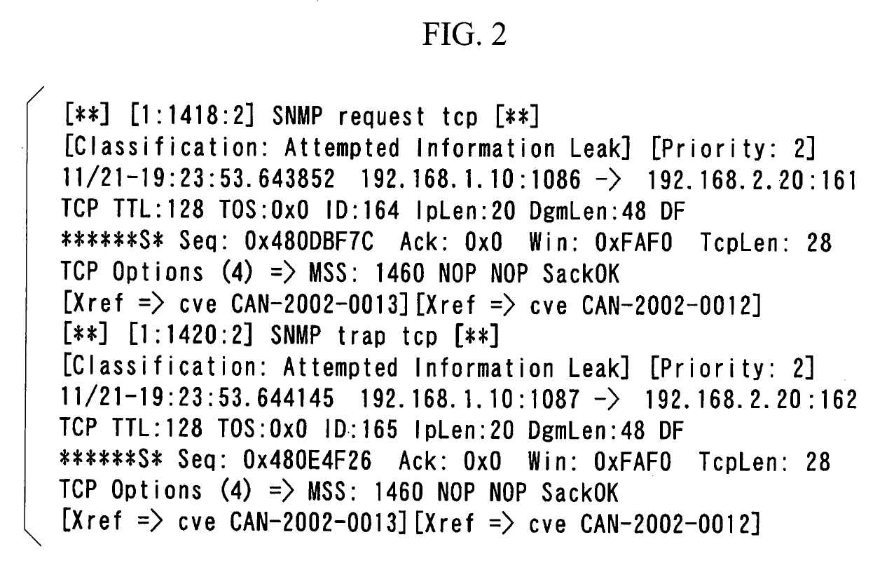

Next, an example of a log that is a subject of processing by the IDS log analysis support system 1 will be described with reference to FIG. 2. Four examples may be given of a log that is a subject of processing by the IDS log analysis support system 1, namely, Snort, ICEcap, SiteProtector, and Secure IDS. FIG. 2 is a view showing an example of display of the content of an Alert file, which is a Snort log.

As is shown in FIG. 2, each log starts with a signature ID and signature name that is enclosed by [**] and continues until the next [**]. Information such as the detection date and time, the Source IP/Port, the Destination IP/Port, and the communication protocol is contained in the log. In addition to Alert files, Snort outputs Scan log files relating to the collection of information. The other three IDS logs (ICEcap, SiteProtector, and Secure IDS) have the same items as Snort log.

(Analysis Parameters and Database Design)

Next, the design of the database 20 will be described. In order to apply an integrated analysis technique to the logs 51 output from each IDS 50, an integrated type of database 20 is designed. The reason for this is to provide an IDS log analysis support system that is easy to use and that does away with the need for analysis skill in each model of IDS 50.

Examples of log items that need to be monitored in order to evaluate the degree of abnormality of each type of attack on the respective sites A, B, and C are given below. The term “each type of attack” refers to information collection for a target host retrieval (level 1), an attempt to intrude into a target host (level 2), a privilege escalation, an erasure, an alteration, an interception, or a concealment after making an intrusion (level 3), an attack on a third party using the target host as a springboard (level 4), and a distributed denial of service (DDOS) attack (level 5).

Firstly, as log items to be monitored, in order to discover which type of attack the IDS 50 operator has detected using which detection engine, the Sensor ID and signature name are set as items of the database 20.

Next, in order to ascertain a sequential relationship between detected signatures/length of attack time/timing between attacks and the like and to implement various statistical processings, timing is monitored and this is set as an item of the database 20.

Next, in order to discover the source and destination of an attack, the Source I/P port and Destination I/P port are monitored and these are set as items of the database 20.

In addition, in order to analyze the communication protocol when an attack has occurred and the reason (attack detection parameter) why it has been determined as an attack and the like, these are also set as items in the database 20.

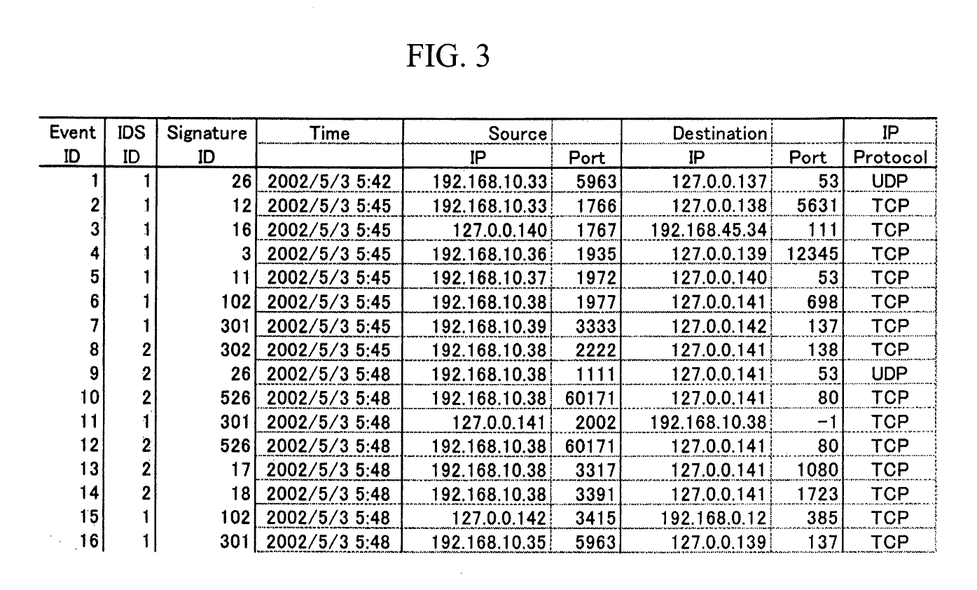

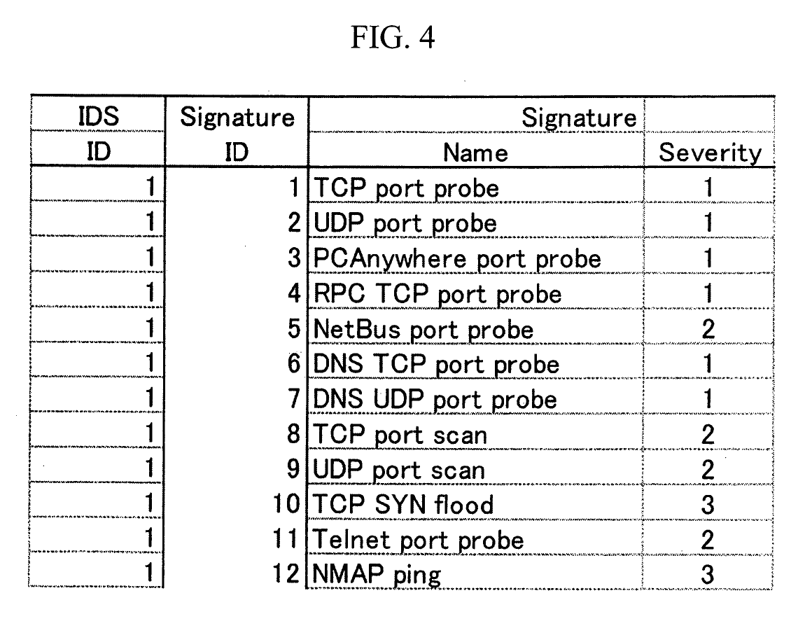

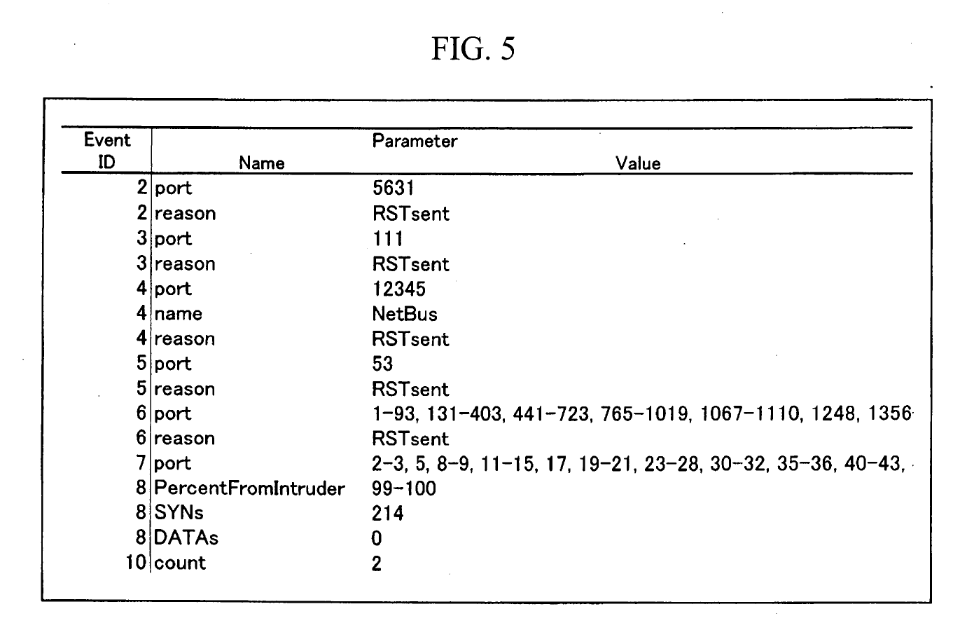

An example of the format of a table of the database 20, which is an integrated DB having the above described elements (items), is shown in FIGS. 3 to 5. FIG. 3 is an event table, FIG. 4 is a signature table, and FIG. 5 is an event parameter table.

(Statistical Analysis)

Next, statistical analysis of the log performed by the log analysis section 30 will be described in detail.

Examples of items of an IDS log analyzed by an operator (via the log analysis section 30) include Source I/P port, Destination I/P port, and Signature name. A statistical value pattern analysis model (i.e., an internal and external similarity analysis model and an access country analysis model), a ratio analysis model (a ratio analysis device), and a threshold learning model (a threshold learning device) can be applied for statistical analysis of the number of events relative to a time base for these items.

The statistical value pattern analysis model performs analysis by monitoring patterns of statistical values of the number of events relative to a time base. An internal and external similarity analysis model (i.e., an internal and external similarity analysis device) and an access country analysis model (i.e., an access country analysis device) can be applied as the statistical value pattern analysis model.

(Internal and External Similarity Analysis Model (Internal and External Similarity Analysis Device))

Attacks using worms and the like are often included in accesses to an internal (i.e., inside the sites A, B, and C) intranet (i.e., a subject of protection) from the Internet, which is outside the subject of protection. Conversely, it can be thought that attacks using worms are usually not included in accesses from an intranet to the Internet. In this way, when access from the Internet is regarded as contaminated traffic, taking the extent to which access from the intranet is similar to contaminated traffic from the outside (i.e., the degree of similarity) as an index, an internal and external similarity analysis model (i.e., an internal and external similarity analysis device) that makes detections and determinations about this degree of similarity is provided in the log analysis section 30, and using this the host infected by a worm and springboard host are detected.

For example, when the degree of similarity is being continuously monitored and the degree of similarity changes abruptly from a normal state (i.e., from an average value), it is determined that an attack is being made or has been made. Namely, in a normal state in which no attack has yet been made, the traffic from the Internet to the intranet and the traffic from the intranet to the Internet are considerably different. If, however, an attack is made, then both the traffic from the Internet to the intranet and the traffic from the intranet to the Internet both enter into a contaminated state and abruptly match each other. In this way, because the above described degree of similarity abruptly changes if an attack is made, by continuously monitoring the degree of similarity it is possible to immediately detect that an attack has been made.

As the method of detecting the host infected by a worms, immediately after an attack on the inside is made from the outside, attacks being made on the same signature name and the same destination port from the inside to the outside, are monitored. It is also possible to pinpoint the source of the attack by IP address.

(Access Country Analysis Model (Access Country Analysis Device))

Normally, the country that is accessing the intranet (i.e., the subject of protection) is often the country to which that intranet belongs, or alternatively, is concentrated in a particular country. Conversely, access from the intranet to the Internet also exhibits the same trend.

When a new attack starts breaking out over the Internet, accesses from countries other than countries that normally make accesses increase. This is because a large number of worms have the characteristic of randomly selecting an attack destination IP address. Moreover, if there are hosts that have become springboards on the intranet, the trend of the accessing countries also changes. Accordingly, if the log analysis section 30 analyzes the differences between the long term profile of a country (i.e., statistical values or data over a long term) and the short term profile (i.e., statistical values or data over a short term) thereof, it becomes possible to ascertain the signs of an attack over the Internet as well as the springboard host on the intranet.

Therefore, the log analysis section 30 is provided with an access country analysis device that takes the name of the country to which the source of the access from the Internet to the intranet belongs, which is in the log 51 (i.e., the inward log), as the subject for detection, and allocates a ranking to the occurrence frequency of that country name. When there is a change in the ranking of the country names that are normally detected, or if there is an increase in the occurrence frequency of a country name that is not normally detected, the access country analysis device determines that an abnormality has occurred. As a result, it is possible to ascertain the outbreak of a new attack on the Internet.

In addition, the log analysis section 30 is provided with an access country analysis device that takes the name of the country to which the destination of the access from the intranet to the Internet belongs, which is in the log 51 (i.e., the outward log), as the subject for detection, and allocates a ranking to the occurrence frequency of that country name. When there is a change in the ranking of the country names that are normally detected, or if there is an increase in the occurrence frequency of a country name that is not normally detected, the access country analysis device determines that an abnormality has occurred. As a result, it is possible to detect that the intranet has been infected by a virus or that a springboard host has been created in the intranet and the like.

(Initial Detection Model)

It is also possible to provide the log analysis section 30 with an initial detection model (an initial detection device) that is shown below as one of the above described statistical value pattern analysis models.

In order to follow faintly remaining traces, it is important to monitor the events first detected from among the vast quantity of logs 51. For an event that from the outset has not been detected even once in a long term profile, it is not possible to apply the various types of statistical analysis. Therefore, the initial detection model (the initial detection device) is provided in the log analysis section 30, and events that have not been detected in the past long term profile but have been newly detected in the short term profile are monitored.

(Ratio Analysis Model (Ratio Analysis Device))

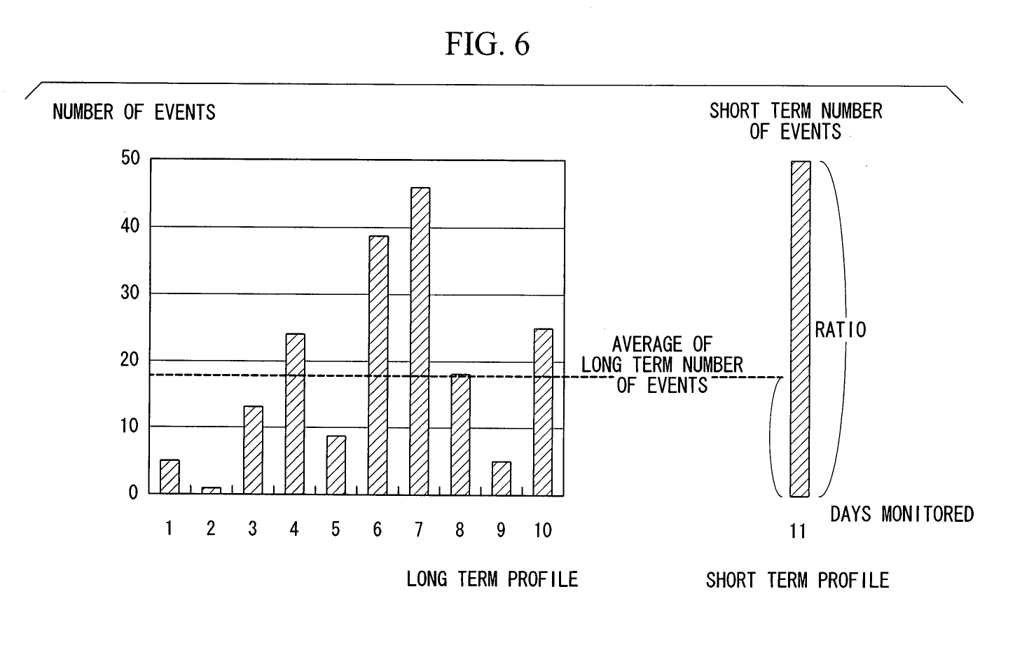

Next, the ratio analysis mode (ratio analysis device) provided in the log analysis section 30 will be described. FIG. 6 is an explanatory view of a ratio analysis model.

A ratio analysis model is a method (a device) in which, with the short time period being observed being taken as a unit time, a scale factor of an average of the number of events contained in a plurality of past unit times (i.e., long term profile) relative to the number of events contained in the short time period (i.e., short term profile) is evaluated as an abnormality value. Therefore, the log analysis section 30 is provided with a ratio analysis device that determines whether or not an abnormality has occurred based on the scale factor (i.e., the ratio) of the long term profile (i.e., the average) relative to the short term profile. FIG. 6 shows the state of the ratio analysis model when the short term profile is taken as one day.

When there are t−1 number of unit times, if the number of events contained in the n^{th} unit time is taken as En, then the ratio Rₜ of the long term profile relative to the t^{th} short term profile is expressed as in Formula (1) below.

$${R}_{t} = \frac{{E}_{t}}{{\sum }_{n = 1}^{t - 1} \frac{{E}_{n}}{t - 1}} \qquad ( 1 )$$

If Rₜ is greater than 1.0, then this shows that the number of events in the short term has abruptly increased such as when a new attack has begun to circulate on the Internet, or when an internal host has been infected by a worm, or when a DDoS attack has been received. Therefore, the ratio analysis model is able to rapidly and accurately detect that an internal host has been infected by a worm or that a DDoS attack has been received.

If Rₜ is less than 1.0, then because this shows that alarms continuously output normally have suddenly decreased or have disappeared due to false positive detection, the ratio analysis model is able to rapidly and accurately discover an abnormality relating to the stopping of the network or host.

(Threshold Learning Model)

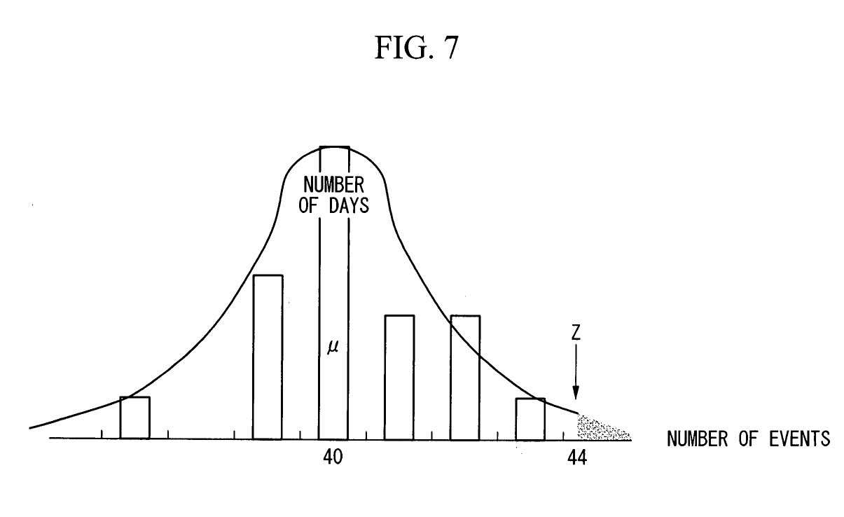

Next, the threshold learning model (the threshold learning device) provided in the log analysis section 30 will be described. FIG. 7 is an explanatory view showing a threshold learning model.

The threshold learning model is a statistical method of determining a confidence interval using an average μ and a standard deviation σ. In the threshold learning model a 95% confidence interval in statistics is used, and the degree of abnormality of the number of events is evaluated from the value Z determined from the average μ and standard deviation σ.

If applied to the present IDS log analysis support system 1, the threshold learning device of the log analysis section 30 calculates to what extent the number of events per unit time is a dispersed value relative to the normally detected number of events (hereinafter referred to as a “rare ratio”). By using the standard deviation σ, it is possible to make an evaluation while considering the degrees of dispersion in past data. Therefore, the threshold learning device of the log analysis section 30 is able to learn a threshold value for each characteristic of signature and IDS 50 such as, for example, attacks in which misdetections normally are continuous such as in the case of a TCP Port Probe and attacks that are sometimes misdetected such as password dictionary attacks.

In FIG. 7, a state of determining a rare ratio is shown when the unit time is taken as one day, the number of events is shown by the horizontal axis, and the vertical axis shows the number of days that that number of events occurred.

The average μ of the number of events when there are N number of unit times is expressed by Formula (2) below.

$$μ = \frac{{\sum }_{n = 1}^{N} {X}_{n}}{N} \qquad ( 2 )$$

The standard deviation σ at this time is expressed by Formula (3) below.

$$σ = \sqrt{\frac{{\sum }_{n = 1}^{N} {( {X}_{n} - μ )}^{2}}{N}} \qquad ( 3 )$$

Using this average μ and standard deviation σ, the Z_{N+1} score (i.e., the Z_{N+1} value) relating to the number of events for the N+1^{th} short term profile is expressed by Formula (4) below.

$${Z}_{N + 1} = \frac{{X}_{N + 1} - μ}{σ} \qquad ( 4 )$$

Based on this Z_{N+1} score, the rare ratio is determined by referring to a Z score table (i.e., a normal distribution table; Z-table).

Generally, in the case of a threshold learning model, it is not possible to correctly determine the confidence interval unless the sample number is 30 or more. Accordingly, when the unit time is one day, it is preferable that a number of events of 30 days or more is used as the sample.

If Z is greater than 0, then this is the same as when Rₜ is greater than 1.0 in the ratio analysis model. Namely, in this case, this shows that the number of events in the short term has abruptly increased such as when a new attack has begun to circulate on the Internet, or when an internal host has been infected by a worm, or when a DDoS attack has been received. Therefore, the threshold learning model is able to rapidly and accurately detect that an internal host has been infected by a worm or that a DDoS attack has been received.

If Z is less than 0, then this is the same as when Rₜ is less than 1.0 in the ratio analysis model. Namely, in this case, because this shows that alarms continuously output normally have suddenly decreased or have disappeared due to false positive detection, the threshold learning model is able to rapidly and accurately discover an abnormality relating to the stopping of the network or host.

(IDS Comparison Model (IDS Comparison Device))

It is preferable that the log analysis section 30 of the IDS log analysis support system 1 is provided with the IDS comparison device described hereinafter. As is shown in FIG. 1, a plurality of IDS 50 are connected to the Internet, and each IDS 50 has a different subject of protection (i.e., the sites A, B, and C). It is preferable that the log analysis section 30 has an IDS comparison device that compares a monitored profile that is a feature of the log 51 of one IDS 50 (i.e., the monitored intrusion detection system) from among the plurality of IDS 50 with an integrated profile that is a feature of the log 51 of all the IDS 50 other than the monitored intrusion detection system from among the plurality of IDS 50, and determines that an abnormality is present when a difference of a predetermined value or greater exists in the comparison result.

By employing this type of structure, when, for example, a plurality of IDS are each monitoring a different subject of protection (i.e., the sires A, B, and C), it is possible to determine whether or not an abnormality has occurred in a particular subject of protection (for example, the site A) from among all of the subjects of protection (i.e., the sites A, B, and C) of the plurality of IDS 50.

Moreover, it is also preferable that the IDS comparison device of the log analysis section 30 has a variable state comparison function (a variable state comparison device) that compares a variable state that accompanies the elapsed time of the monitored profile with a variable state that accompanies the elapsed time of an integrated profile, and determines that an abnormality is present when a difference of a predetermined value or greater exists in the comparison result. By employing this type of structure, when, for example, the variable state of the integrated profile is stable, then if the variable state of the monitored profile abruptly increased for a predetermined item, it is possible to determine that there is a possibility that a worm has infected a subject of protection (for example, the site A) of a particular IDS 50.

(Effect of the Present Embodiment)

Next, the effect of the IDS log analysis support system of the present embodiment will be described.

The ratio analysis model (the ratio analysis device) and the threshold learning model (the threshold learning device) that are provided in the log analysis section 30 are techniques of ignoring redundant logs and objectively evaluating logs that are different from normal. Therefore, the ratio analysis model (the ratio analysis device) and the threshold learning model (the threshold learning device) not only do not require tasks such as policy tuning and filtering a log for which countermeasures have been implemented in order to reduce redundant logs (Effect 1), but they are able to objectively ascertain features that are different from normal (Effect 2).

The initial detection model (the initial detection device) provided in the log analysis section 30 is a technique of extracting faint traces that tend to be buried in a vast quantity of logs, and does not overlook logs that have a low frequency of occurrence (Effect 3).

The internal and external similarity analysis model (the internal and external similarity analysis device) and the access country analysis model (the access country analysis device) provided in the log analysis section 30 are able to rapidly and accurately detect a host infected by a worm and a springboard host (Effect 4).

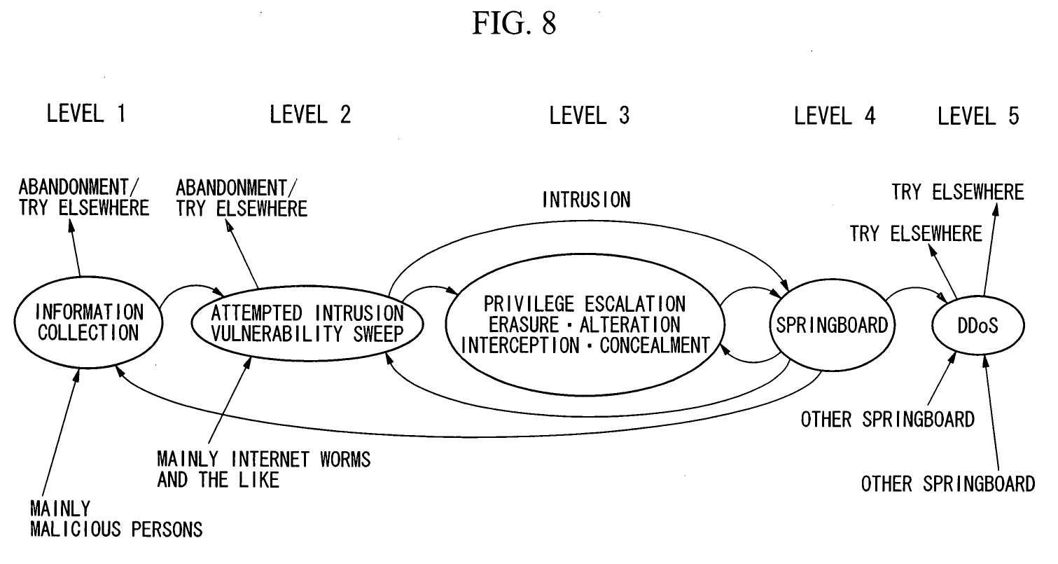

Next, the effects of the IDS log analysis support system of the present embodiment against various types of attacks will be described with reference made to FIG. 8. FIG. 8 is an explanatory view showing a variety of attack modes on the sites A, B, and C, which are subjects of protection of the IDS 50.

Generally, an attack includes steps such as searching for vulnerability in a target, attempting an intrusion by attacking a weak point, and using the target as a springboard after making an intrusion. Naturally, there are also many attacks that perform fewer steps such as Internet worms (i.e., worms) that make an intrusion by suddenly attacking vulnerability and repeating the same attacks on other sites from the intruded site. In FIG. 8, attacks are classified into 5 levels for each step. Firstly, the attack method and characteristics for each step as well as the traces remaining in the IDS log will be described.

An example of a Level 1 attack includes an information collection. An information collection is an attack that attempts an IP scan in order to search for a target host, a Port scan in order to search for vulnerability in a host, and a Finger Print and the like. Traces of accesses to a plurality of IP and of accesses to a plurality of Ports remains in the IDS log. Additional examples include interceptions of traffic on hubs or routers, however, these cannot normally be detected by the IDS 50.

Examples of a level 2 attack include an intrusion attempt and a vulnerability sweep. An intrusion attempt and a vulnerability sweep include a password dictionary attack, connection hijacks, buffer overflow attacks that attack weak points in design and bugs in programs, and exploit attacks. In the case of widely circulating worms and attacks that use attack tools, traces of the same pattern remain.

Examples of a level 3 attack include a privilege escalation, an erasure, an alteration, an interception, or concealment after making an intrusion. The privilege escalation, erasure, alteration, interception, and concealment after making an intrusion refer to a local privilege escalation, an erasure of data on a hard disk, an alteration of contents and the like of a home page, an interception of significant data, and a concealment of an evidence log after an intrusion has been made. Once an intrusion has been permitted, the making of a distinction by the IDS 50 between these attack steps and normal usage is difficult, and practically no trace is left in the log 51.

An example of a Level 4 attack is a springboard. A springboard is an attempt to attack another host from a host into which an intrusion has been made. In particular, when a worm infection has occurred, attacks that have previously come at times from a plurality of external hosts conversely attack a plurality of external hosts, so that a large quantity of logs are recorded.

An example of a Level 5 attack is a DDoS. In a DDoS, there is a traffic overflow attack such as from Smurf or the Trojan horse program. In this case, traces of the same pattern remain from a plurality of external hosts to a specific internal host or from a plurality of internal hosts to a specific external host.

For a level 1 attack, the IDS log analysis support system 1 of the present embodiment is able to extract a Source IP (i.e., an attack source) that persistently collects information using the ratio analysis model or the threshold learning model. It is also able to ascertain a Source IP that has attempted a new attack using the initial detection model.

For a level 2 attack, the IDS log analysis support system 1 is able to objectively evaluate the attack size and host infected by a worm showing a new circulation on the Internet using the internal and external similarity analysis model, the access country analysis model, the ratio analysis model, and the threshold learning model.

For a level 3 attack, little can be expected as there is practically nothing recorded on the log 51 of an IDS 50 of the current technology. However, by using an IDS 50 that is capable of recording a level 3 attack in the log 51, it is possible to rapidly detect a level 3 attack using the IDS log analysis support system 1.

For a level 4 attack, the IDS log analysis support system 1 is able to capture characteristics of attacks remarkably using the internal and external similarity analysis model, the access country analysis model, the ratio analysis model, and the threshold learning model.

For a level 5 attack, the ratio analysis model and the threshold learning model of the IDS log analysis support system 1 are suitable for ascertaining the size of an attack.

By using these techniques, the IDS log analysis support system 1 of the present embodiment is able to manage in an integrated manner the large quantity of logs 51 output from the variety of IDS 50 using the database 20, and to perform statistical analysis relating to each type of item using the log analysis section 30. Therefore, in the monitoring of a network that previously relied on the skill of an operator, the IDS log analysis support system 1 is able to calculate an objective degree of abnormality.

Namely, the IDS log analysis support system 1 has an integrated database that is capable of managing logs 51 from a variety of IDS 50, and a log analysis section 30 that serves as a statistical analysis device for analyzing these logs is provided with a statistical value pattern analysis model (i.e., an internal and external similarity analysis device and an access country analysis device) that evaluates differences in a short term profile compared to a long term profile, a ratio analysis model (a ratio analysis device), and a threshold learning model (a threshold learning device). By using these statistical analysis devices, an intruder who makes persistent attacks, an attack that has newly appeared on the Internet, a host infected by a worm, and a springboard host and the like can be quickly discovered based on the logs 51 that contain a large number of redundant logs such as misdetections and multiple detections.

An embodiment of the present invention has been described above in detail with reference made to the drawings, however, the specific structure of the present invention is not limited to these embodiments and various design modifications are possible insofar as they do not depart from the gist of the present invention.

The IDS log analysis support system of the above described embodiment may be realized as an IDS log analysis support program that executes operations and functions of the IDS log analysis support system via a computer. Here, the term “computer” includes home page providing environments (or displaying environments) if a WWW system is being used. Moreover, this IDS log analysis support program may also be transmitted from a computer that has stored this program in a storage device or the like to another computer via a transmission medium or via a transmission wave in the transmission medium. Here, the term “transmission medium” that transmits the program refers to a medium having a function of transmitting information such as a network (i.e., a telecommunication network) such as the Internet or a telecommunication circuit (i.e., a telecommunication line) such as a telephone circuit. The aforementioned IDS log analysis support program may also be designed to perform only a portion of the above described functions. Furthermore, the aforementioned IDS log analysis support program may also be what is known as a differential file (i.e., a differential program) that performs the above described functions by combining with a program already recorded on the computer.

What is claimed is:

1. An IDS log analysis support apparatus comprising:
a log collection section that collects a log of an intrusion detection system that is connected to a telecommunication network;
a database that stores and manages logs collected by the log collection section; and
a log analysis section that obtains statistics of the logs managed by the database and analyses the statistics.

2. The IDS log analysis support apparatus according to claim 1, wherein the log analysis section comprises an internal and external similarity analysis device that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected subject side, and sequentially calculates a degree of similarity that shows an extent to which the inward log and the outward log match based on the result of the comparison, and determines whether or not an abnormality has occurred based on the degree of similarity.

3. The IDS log analysis support apparatus according to claim 1, wherein the log analysis section comprises an access country analysis device that, taking as a subject to be detected a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

4. The IDS log analysis support apparatus according to claim 1, wherein the log analysis section comprises an access country analysis device that, taking as a subject to be detected a name of a country to which belongs a transmission source of an inward log in the logs, which is a log of accesses made from a non-protected subject side of the intrusion detection system to a protected subject side of the intrusion detection system, determines that an abnormality has occurred when there is an increase in the occurrence frequency of a country name that is not normally detected.

5. The IDS log analysis support apparatus according to claim 1, wherein the log analysis section comprises an access country analysis device that, taking as a subject to be detected a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

6. The IDS log analysis support apparatus according to claim 1, wherein the log analysis section comprises an access country analysis device that, taking as a subject to be detected a name of a country to which belongs a transmission destination of an outward log, which is a log of accesses made from a protected subject side of the intrusion detection system to a non-protected subject side of the intrusion detection system that are in the logs, determines that an abnormality has occurred when there is an increase in the occurrence frequency of a country name that is not normally detected.

7. The IDS log analysis support apparatus according to claim 1, wherein the log analysis section comprises a ratio analysis device that compares a short term number of events, which is the number of a predetermined event contained in a predetermined unit time period in the logs, with an average value of a short term number of events for a plurality of the unit time periods, and determines whether or not an abnormality has occurred based on a ratio of the short term number of events relative to the average value.

8. The IDS log analysis support apparatus according to claim 1, wherein the log analysis section comprises a threshold learning device that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

9. The IDS log analysis support apparatus according to claim 1, wherein a plurality of intrusion detection systems are connected to the telecommunication network, and the plurality of intrusion detection systems each have a different protected subject, and the log analysis section comprises an IDS comparison device that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

10. The IDS log analysis support apparatus according to claim 9, wherein the IDS comparison device comprises a variable state comparison device that compares a variable state that accompanies an elapsed time of the monitored profile with a variable state that accompanies an elapsed time of the integrated profile, and determines that an abnormality has occurred when the difference between the variable states is equal to or greater than a predetermined value.

11. An IDS log analysis support method comprising the steps of:
regularly collecting a log of an intrusion detection system that is connected to a telecommunication network;
storing logs in a database and managing the logs; and
obtaining statistics of the logs managed by the database and performing analysis processing on the statistics.

12. The IDS log analysis support method according to claim 11, wherein the analysis processing comprises internal and external similarity analysis processing that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected subject side, and determines whether or not an abnormality has occurred using a degree of similarity that shows an extent to which the inward log and the outward log match based on the results of the comparison.

13. The IDS log analysis support method according to claim 11, wherein the analysis processing comprises access country analysis processing that sequentially detects an occurrence frequency of a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

14. The IDS log analysis support method according to claim 11, wherein the analysis processing comprises access country analysis processing that sequentially detects an occurrence frequency of a name of a country to which belongs a transmission source of an inward log in the logs, which is a log of accesses made from a non-protected subject side of the intrusion detection system to a protected subject side of the intrusion detection system, and determines that an abnormality has occurred when there is an increase in the occurrence frequency of a country name that is not normally detected.

15. The IDS log analysis support method according to claim 11, wherein the analysis processing comprises access country analysis processing that sequentially detects an occurrence frequency of a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

16. The IDS log analysis support method according to claim 11, wherein the analysis processing comprises access country analysis processing that sequentially detects an occurrence frequency of a name of a country to which belongs a transmission destination of an outward log in the logs, which is a log of accesses made from a protected subject side of the intrusion detection system to a non-protected subject side of the intrusion detection system, and determines that an abnormality has occurred when there is an increase in the occurrence frequency of a country name that is not normally detected.

17. The IDS log analysis support method according to claim 11, wherein the analysis processing comprises ratio analysis processing that sequentially calculates a ratio between a short term number of events, which is the number of a predetermined event contained in a predetermined time period in the logs, and a long term number of events, which is the number of the predetermined event contained in a time period that is longer than the predetermined time period, and determines whether or not an abnormality has occurred based on the ratio.

18. The IDS log analysis support method according to claim 11, wherein the analysis processing comprises threshold learning analysis processing that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

19. The IDS log analysis support method according to claim 11, wherein a plurality of intrusion detection systems are connected to the telecommunication network, and the plurality of intrusion detection systems each have a different protected subject, and the analysis processing comprises IDS comparison processing that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

20. The IDS log analysis support method according to claim 19, wherein the IDS comparison processing comprises variable state comparison processing that compares a variable state that accompanies an elapsed time of the monitored profile with a variable state that accompanies an elapsed time of the integrated profile, and determines that an abnormality has occurred when the difference between the variable state is equal to or greater than a predetermined value.

21. An IDS log analysis support program that analyzes a log of an intrusion detection system connected to a telecommunication network, the IDS log analysis support program executing on a computer:
a log collection step in which logs are collected from the intrusion detection system;
a database creation step in which the logs collected in the log collection step are stored and the stored logs are managed; and
a log analysis step in which statistics are obtained for the logs managed in the database creation step and the statistics are analyzed.

22. The IDS log analysis support program according to claim 21, wherein the log analysis step comprises an internal and external similarity analysis step that sequentially compares an inward log in the logs, which is a log of accesses made from a non-protected subject side of the intrusion detection system to a protected subject side of the intrusion detection system, with an outward log in the logs, which is a log of accesses made from the protected subject side to the non-protected object side, and determines whether or not an abnormality has occurred using a degree of similarity that shows an extent to which the inward log and the outward log match based on the result of the comparison.

23. The IDS log analysis support program according to claim 21, wherein the log analysis step comprises an access country analysis step that sequentially detects an occurrence frequency of a name of a country to which belongs a transmission source of an inward log in the logs, which is a log of accesses made from a non-protected subject side of the intrusion detection system to a protected subject side of the intrusion detection system, allocates a ranking to occurrence frequencies of country names, and determines that an abnormality has occurred when there is a change in the ranking of the country names that are normally detected.

24. The IDS log analysis support program according to claim 21, wherein the log analysis step comprises an access country analysis step that sequentially detects an occurrence frequency of a name of a country to which belongs a transmission source of an inward log in the logs, which is a log of accesses made from a non-protected subject side of the intrusion detection system to a protected subject side of the intrusion detection system, and determines that an abnormality has occurred when there is an increase in the occurrence frequency of a country name that is not normally detected.

25. The IDS log analysis support program according to claim 21, wherein the log analysis step comprises an access country analysis step that sequentially detects an occurrence frequency of a name of a country to which belongs a transmission destination of an outward log in the logs, which is a log of accesses made from a protected subject side of the intrusion detection system to a non-protected subject side of the intrusion detection system, allocates a ranking to occurrence frequencies of country names, and determines that an abnormality has occurred when there is a change in the ranking of the country names that are normally detected.

26. The IDS log analysis support program according to claim 21, wherein the log analysis step comprises an access country analysis step that sequentially detects an occurrence frequency of a name of a country to which belongs a transmission destination of an outward log in the logs, which is a log of accesses made from a protected subject side of the intrusion detection system to a non-protected subject side of the intrusion detection system, and determines that an abnormality has occurred when there is an increase in the occurrence frequency of a country name that is not normally detected.

27. The IDS log analysis support program according to claim 21, wherein the log analysis step comprises a ratio analysis step that sequentially calculates a ratio between a short term number of events, which is the number of a predetermined event contained in a predetermined time period in the logs, and a long term number of events, which is the number of the predetermined event contained in a time period that is longer than the predetermined time period, and determines whether or not an abnormality has occurred based on the ratio.

28. The IDS log analysis support program according to claim 21, wherein the log analysis step comprises a threshold learning analysis step that calculates a short term number of events, which is the number of a predetermined event contained in a predetermined unit time period in the logs, and an average value of a short term number of events for a plurality of the unit time periods, and a standard deviation value of a short term number of events for a plurality of the unit time periods, and determines whether or not an abnormality has occurred using a result obtained by dividing a difference between the short term number of events of a subject being investigated and the average value by the standard deviation value.

29. The IDS log analysis support program according to claim 21, wherein a plurality of the intrusion detection systems are connected to the telecommunication network, and the plurality of intrusion detection systems each have a different protected subject, and the log analysis step comprises an IDS comparison step that compares a monitored profile, which is characteristics of logs of a monitored intrusion detection system, which is one intrusion detection system from among the plurality of intrusion detection systems, with an integrated profile, which is characteristics of logs of all the intrusion detection systems other than the monitored intrusion detection system from among the plurality of intrusion detection systems, and determines that an abnormality has occurred when the difference between the monitored profile and the integrated profile is equal to or greater than a predetermined value.

30. The IDS log analysis support program according to claim 29, wherein the IDS comparison step comprises a variable state comparison step that compares a variable state that accompanies an elapsed time of the monitored profile with a variable state that accompanies an elapsed time of the integrated profile, and determines that an abnormality has occurred when the difference between the variable states is equal to or greater than a predetermined value.
